(19) United States
(12) Patent Application Publication
(10) Pub. No.: US 2022/0212331 A1
(43) Pub. Date: Jul. 7, 2022

(54) Detachable Handle Case For Electric Hand Tool

(71) Applicants: Xueming XU, Shengzhou (CN); Zhejiang Toolux Imp/Exp Co., Ltd., Ningbo (CN)

(72) Inventors: Xueming XU, Shengzhou (CN); Guanghai YANG, Ningbo (CN)

(21) Appl. No.: 17/141,057

(22) Filed: Jan. 4, 2021

(51) Int. Cl. B25F 5/02; B25B 21/00

(52) U.S. Cl. CPC B25F 5/02; A61H 23/02; B25F 5/029; B25B 21/00

(57) ABSTRACT

A hand tool is sleeved in a detachable handle case. The hand tool includes an elongated handle and a tool head extended from a first end of the handle, wherein the handle has a peripheral surface and a first retention structure formed thereon. The detachable handle case includes a handle sleeve having a hollow structure for receiving the handle of the hand tool therein and defining an inner surface and an outer surface. The handle sleeve includes an anti-slip arrangement formed at the outer surface and a second retention structure formed on the inner surface to engage with the first retention structure for preventing a relative movement between the handle sleeve and the handle.

### CROSS REFERENCE OF RELATED APPLICATION

This is a U.S. non-provisional application that claims priority to first U.S. non-provisional application, application Ser. No. 29/757,704, filed Nov. 9, 2020, which claims priority under 35 U.S.C. § 119 to Chinese application number CN 202030228040.8, filed and May 18, 2020, and second U.S. non-provisional application, application Ser. No. 29/757,708, filed Nov. 9, 2020, which claims priority under 35 U.S.C. § 119 to Chinese application number CN 202030228038.0, filed and May 18, 2020, the entire contents of each of which are expressly incorporated herein by reference.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to hand tools, and more particularly to a detachable handle case for an electric hand tool, wherein a handle of the hand tool is detachably sleeved in the detachable handle case to improve the grip of the hand tool and to protect the hand tool from damage.

### Description of Related Arts

A hand tool, such as a screw driver, generally comprises a handle and a tool head extended from the handle. Accordingly, the handle has an enlarged diameter size and a gripping surface, wherein the handle is designed for a user to grip and turn the handle to apply a rotational force at the tool head so as to tighten or loosen the screw. In order to effectively apply the rotational force at the tool head, the user must grasp the handle tightly. However, different users have different hand sizes. In other words, the user with a smaller hand size may need a smaller diameter of the handle and the user with a larger hand size may easily grasp a larger diameter of the handle.

An improved hand tool, which is an electric hand tool is incorporated with an electric motor, wherein the electric motor is received in the handle to power the tool head. Therefore, once the electric motor is activated, the electric motor will generate the rotational force to the tool head, such that the user is able grasp the handle tightly without turning the handle. However, the handle of the electric motor may not be securely grasped by the users with different hand sizes. In addition, the major drawback of the electric hand tool is that the vibration generated by the electric motor will directly transmit to the user's hand through the handle. The higher the power generated by the electric motor, the greater vibration the user will feel. The vibration will cause the misalignment of the too head to the same angle as that of the screw. In other words, due to the vibration, the user is hard to keep the tool head aligned with the shaft of the screw to tighten or loosen it for the best results.

### SUMMARY OF THE PRESENT INVENTION

The invention is advantageous in that it provides a detachable handle case for an electric hand tool, wherein a handle of the hand tool is detachably sleeved in the detachable handle case to improve the grip of the hand tool and to protect the hand tool from damage.

Another advantage of the invention is to a detachable handle case for an electric hand tool, wherein the handle of the hand tool is snug-fitted in the handle sleeve which is made of anti-slip material to prevent any unwanted movement of the handle within the handle sleeve.

Another advantage of the invention is to a detachable handle case for an electric hand tool, wherein the tool head is enclosed within a tool head cover, such that when the electric hand tool is powered off, the tool head is protected by the tool head cover, and when the electric hand tool is powered on, the tool head cover serves as a massaging tip.

Another advantage of the invention is to a detachable handle case for an electric hand tool, wherein first and second retention structures are provided at a peripheral surface of the handle and an inner surface of the handle sleeve, such that the first and second retention structures are engaged with each other for preventing a relative movement between the handle sleeve and the handle.

Another advantage of the invention is to a detachable handle case for an electric hand tool, wherein two or more anti-slip patterns integrally formed at the outer surface of the handle sleeve to enhance the anti-slipping ability of the handle sleeve and to improve the gripping ability of the handle sleeve.

Another advantage of the invention is to a detachable handle case for an electric hand tool, the coupling operation of the detachable handle case is easy and quick by simply sliding the electric hand tool into the detachable handle case.

Another advantage of the invention is to a detachable handle case for an electric hand tool, which does not require to alter the original structural design of the electric hand tool, so as to minimize the manufacturing cost of the detachable handle case incorporating with the electric hand tool.

Another advantage of the invention is to a detachable handle case for an electric hand tool, wherein no expensive and complicated structures are required to be employed in the present invention in order to achieve the above mentioned objects. Therefore, the present invention successfully provides an economic and efficient solution for improving the grip of the hand tool and for protecting the hand tool from damage.

Additional advantages and features of the invention will become apparent from the description which follows, and may be realized by means of the instrumentalities and combinations particular point out in the appended claims.

According to the present invention, the foregoing and other objects and advantages are attained by an apparatus which comprises a hand tool detachably sleeved in a detachable handle case.

The hand tool comprises an elongated handle and a tool head extended from a first end of the handle, wherein the handle has a peripheral surface and a first retention structure formed thereon.

The detachable handle case comprises a handle sleeve having a hollow structure for receiving the handle of the hand tool therein and defining an inner surface and an outer surface. The handle sleeve comprises an anti-slip arrangement formed at the outer surface and a second retention structure formed on the inner surface to engage with the first retention structure for preventing a relative movement between the handle sleeve and the handle.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a front view of an electric hand tool of a hand tool apparatus according to a preferred embodiment of the present invention.

FIG. 2 is a rear view of the electric hand tool according to the preferred embodiment of the present invention.

FIG. 3 is a left view of the electric hand tool according to the preferred embodiment of the present invention.

FIG. 4 is a right view of the electric hand tool according to the preferred embodiment of the present invention.

FIG. 5 is a top view of the electric hand tool according to the preferred embodiment of the present invention.

FIG. 6 is a bottom view of the electric hand tool according to the preferred embodiment of the present invention.

FIG. 7 is a perspective view of the electric hand tool according to the preferred embodiment of the present invention, illustrating a tool cap detachably coupled at an handle to enclose a tool head.

FIG. 8 is a perspective view of the electric hand tool according to the preferred embodiment of the present invention, illustrating the tool cap being detach from the handle to expose the tool head.

FIG. 9 is a front view of an alternative mode of the electric hand tool according to the preferred embodiment of the present invention.

FIG. 10 is a rear view of the alternative mode of the electric hand tool according to the preferred embodiment of the present invention.

FIG. 11 is a left view of the alternative mode of the electric hand tool according to the preferred embodiment of the present invention.

FIG. 12 is a right view of the alternative mode of the electric hand tool according to the preferred embodiment of the present invention.

FIG. 13 is a top view of the alternative mode of the electric hand tool according to the preferred embodiment of the present invention.

FIG. 14 is a bottom view of the alternative mode of the electric hand tool according to the preferred embodiment of the present invention.

FIG. 15 is a perspective view of the alternative mode of the electric hand tool according to the preferred embodiment of the present invention, illustrating a tool head cover detachably coupled at an handle to enclose a tool head.

FIG. 16 is a front view of a detachable handle case of the hand tool apparatus according to the preferred embodiment of the present invention.

FIG. 17 is a rear view of the detachable handle case according to the preferred embodiment of the present invention.

FIG. 18 is a right view of the detachable handle case according to the preferred embodiment of the present invention.

FIG. 19 is a left view of the detachable handle case according to the preferred embodiment of the present invention.

FIG. 20 is a top view of the detachable handle case according to the preferred embodiment of the present invention.

FIG. 21 is a bottom view of the detachable handle case according to the preferred embodiment of the present invention.

FIG. 22 is a perspective view of the detachable handle case according to the preferred embodiment of the present invention, illustrating a tool head cover detachably coupled at a handle sleeve.

FIG. 23 is a perspective view of the detachable handle case according to the preferred embodiment of the present invention, illustrating the tool head cover detached from the handle sleeve to expose the tool head.

FIG. 24 is front view of an alternative mode of the detachable handle case according to the preferred embodiment of the present invention.

FIG. 25 is a rear view of the alternative mode of the detachable handle case according to the preferred embodiment of the present invention.

FIG. 26 is a left view of the alternative mode of the detachable handle case according to the preferred embodiment of the present invention.

FIG. 27 is a right view of the alternative mode of the detachable handle case according to the preferred embodiment of the present invention.

FIG. 28 is a top view of the alternative mode of the detachable handle case according to the preferred embodiment of the present invention.

FIG. 29 is a bottom view of the alternative mode of the detachable handle case according to the preferred embodiment of the present invention.

FIG. 30 is a perspective view of the alternative mode of the detachable handle case according to the preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

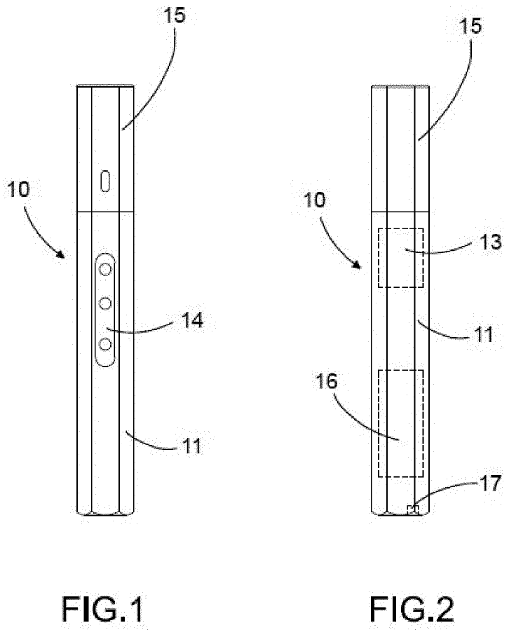

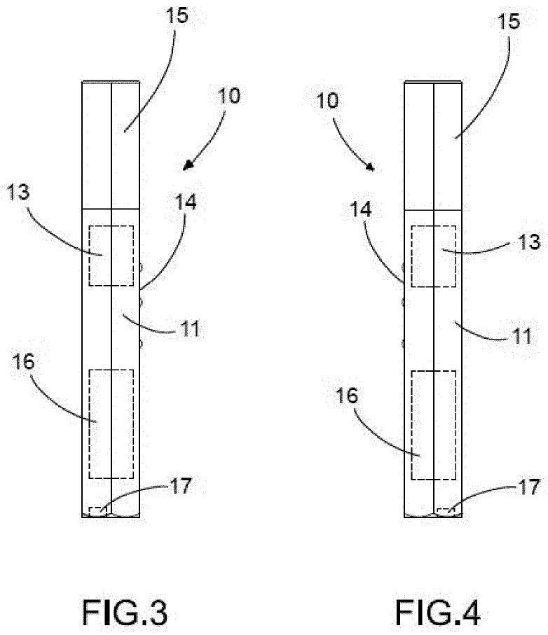

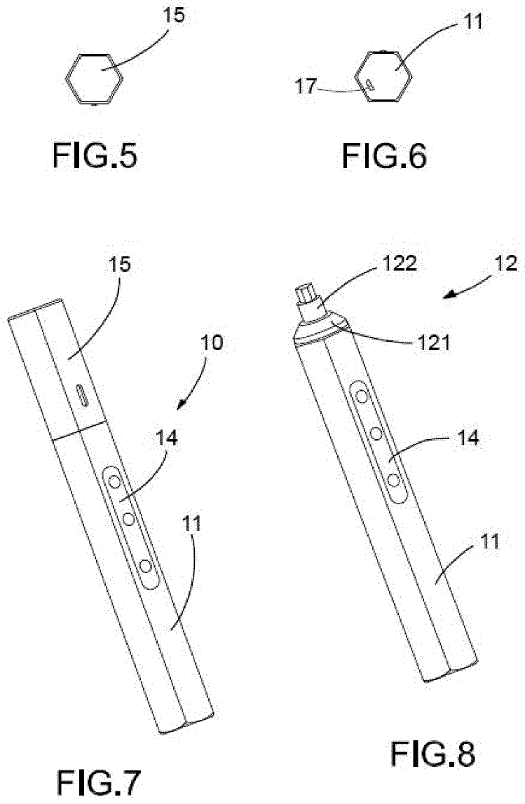

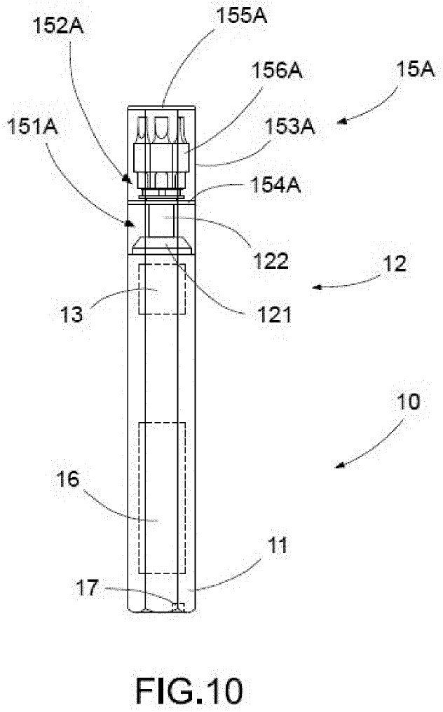

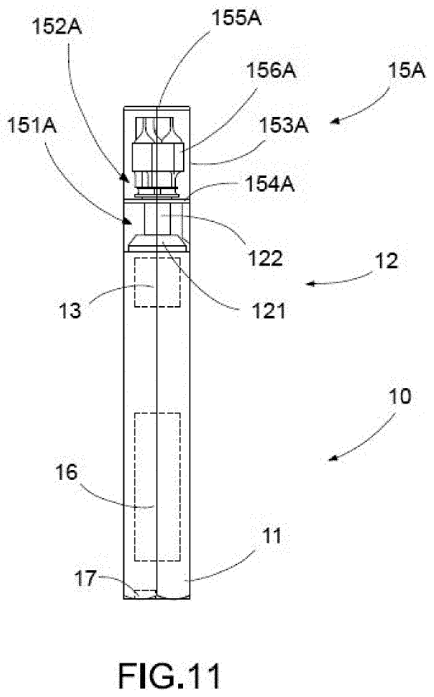

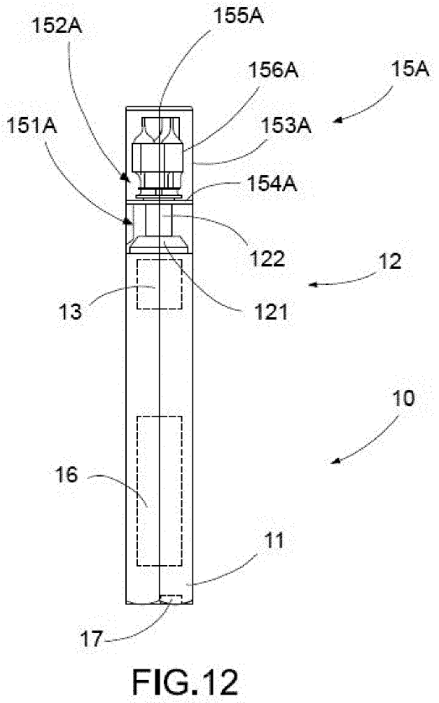

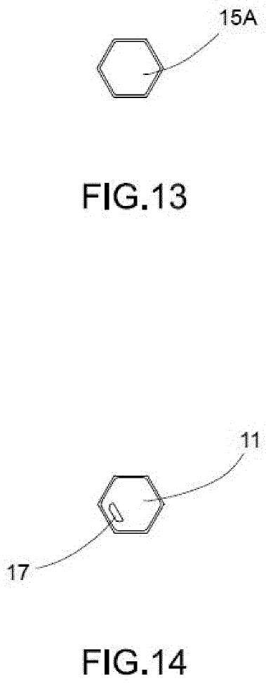

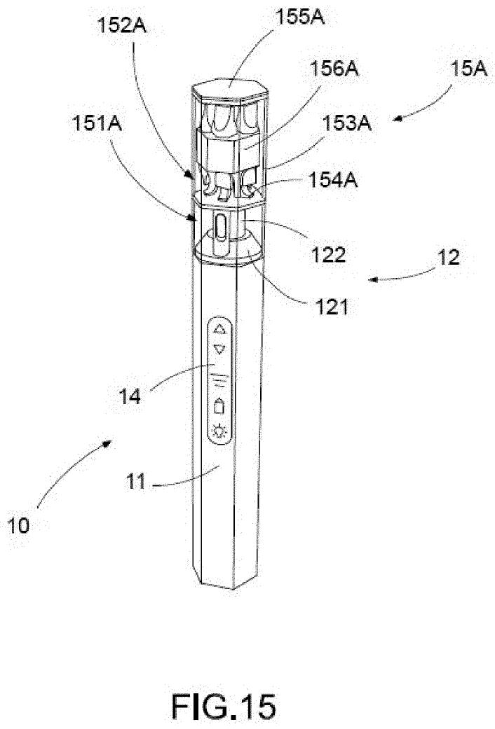

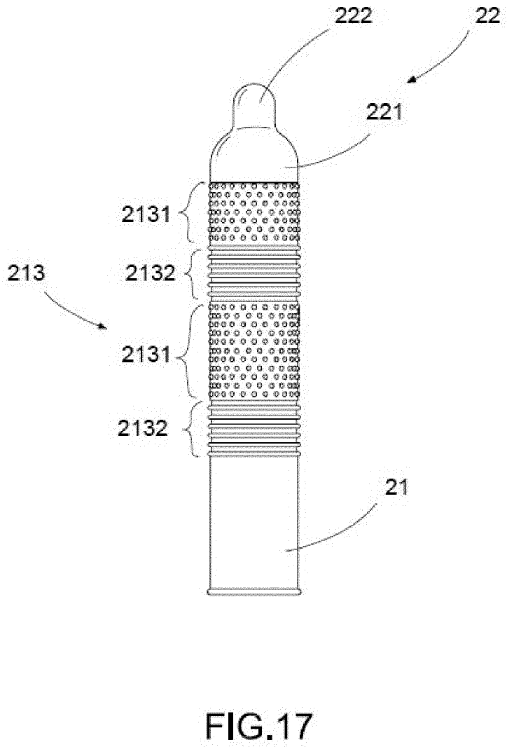

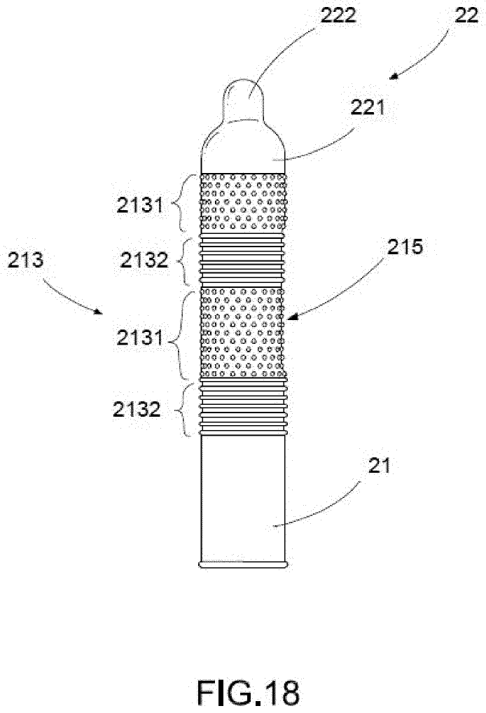

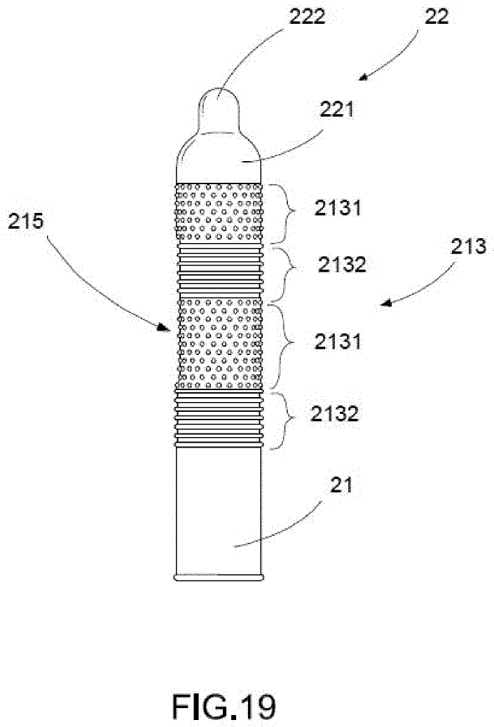

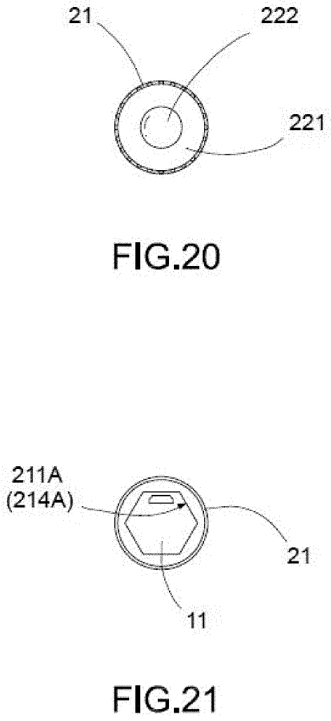

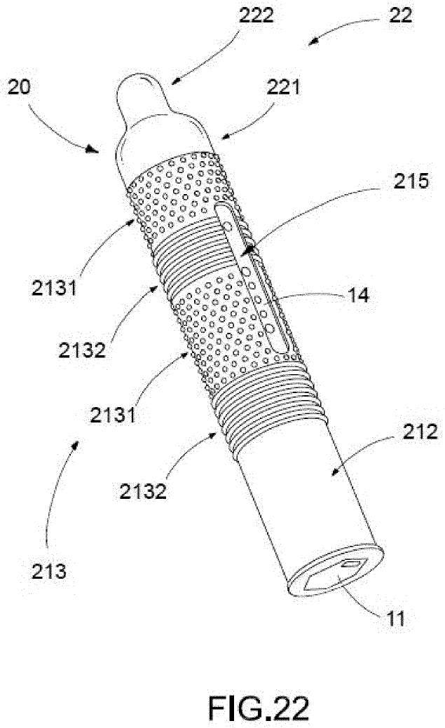

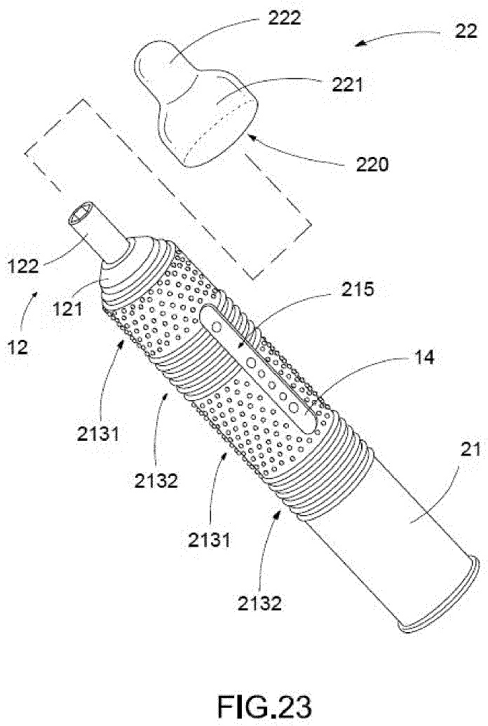

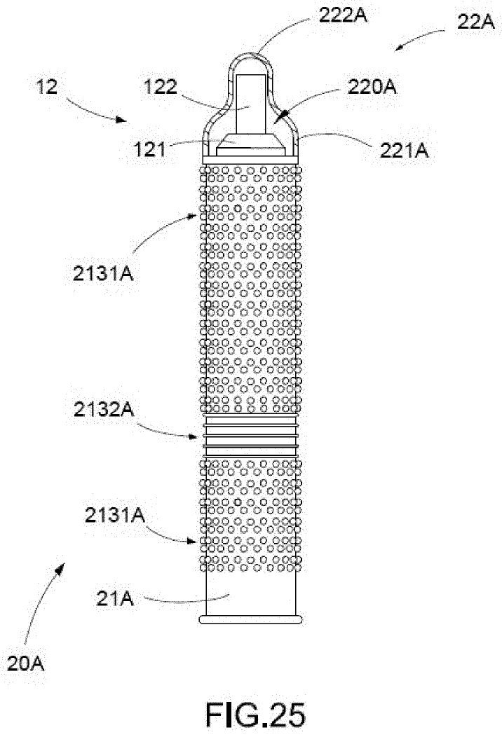

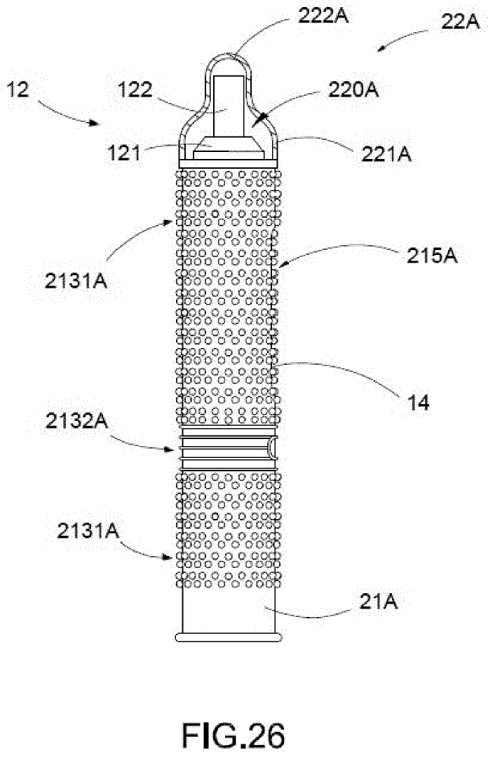

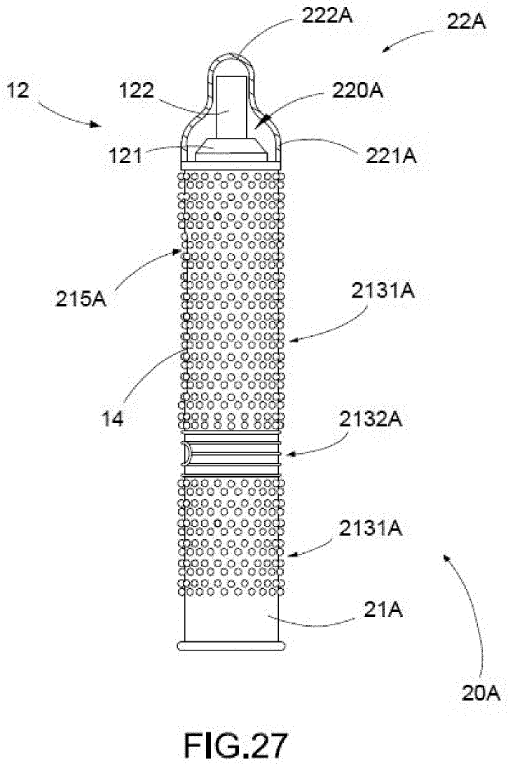

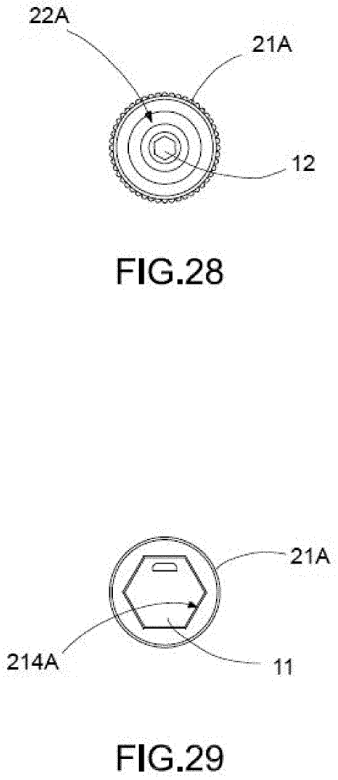

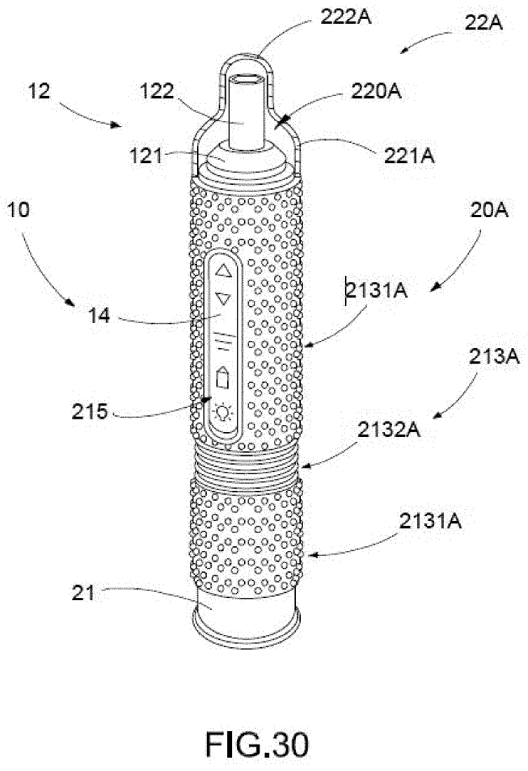

Referring to FIGS. 1 to 30 of the drawings, a hand tool apparatus according to a preferred embodiment of the present invention is illustrated, wherein the apparatus comprises a hand tool 10 and a detachable handle case 20 for detachably receiving the hand tool 10 therein.

As shown in FIGS. 1 to 8, the hand tool 10 comprises an elongated handle 11 and a tool head 12 extended from a first end of the handle 11, wherein the handle 11 has a peripheral surface 111 and a first retention structure 112 formed thereon.

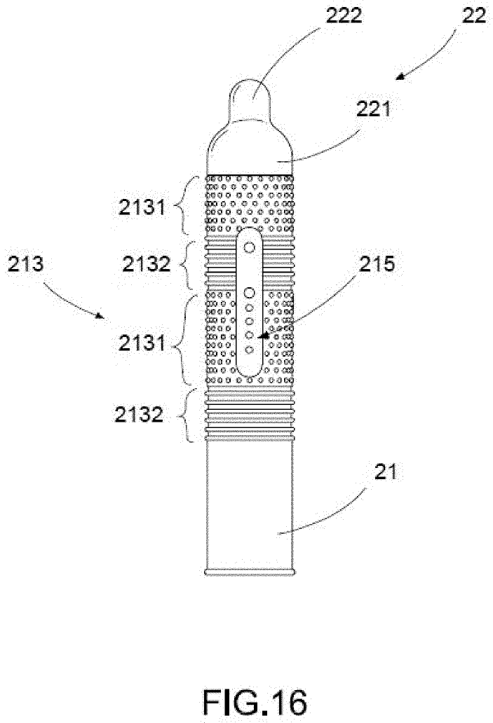

As shown in FIGS. 16 to 23, the detachable handle case 20 comprises a handle sleeve 21 having a hollow structure to form a receiving channel 210 for receiving the handle 11 of the hand tool 10 therein and defining an inner surface 211 and an outer surface 212. The handle sleeve 21 comprises an anti-slip arrangement 213 formed at the outer surface 212 and a second retention structure 214 formed on the inner surface 211 to engage with the first retention structure 112 for preventing a relative movement between the handle sleeve 21 and the handle 11. In other words, the handle sleeve 21 is configured to serve as a handle skin of the handle 11 of the hand tool 10 when the handle 11 is received in the handle sleeve 21.

According to the preferred embodiment, the handle 11 has a uniform cross sectional area between the first end and an opposed second end. In one embodiment, the handle 11 has a polygonal cross section defining a plurality of flat planar surfaces extended between the first and second ends, wherein the flat planar surfaces integrally aligned edge-to-edge to form the peripheral surface 111 of the handle 11. In one example, the handle 11 has a hexagonal cross section to form six flat planar surfaces.

Accordingly, the first retention structure 112 is integrated with the peripheral surface 111 of the handle 11. In one embodiment, the first retention structure 112 forms with at least one of the flat planar surfaces. It is appreciated that the first retention structure 112 is integrated with the handle 11 to have a non-circular cross section. For example, the handle 11 can be configured to have an arc-circular cross section with a flat planar surface.

The tool head 12 of the hand tool 10 comprises a neck extension 121 extended from the first end of the handle 11 and a tool socket 122 extended from the neck extension 121, wherein the handle 11, the neck extension 121 and the tool socket 122 are coaxially aligned with each other. Accordingly, the tool socket 122 is configured for detachably coupling a tool bit. As shown in FIG. 8, the tool bit is coupled at the tool socket 122 of the hand tool 10. In addition, a cross sectional area of the tool socket 122 is smaller than a cross sectional area of the neck extension 121 which is smaller than the cross sectional area of the handle 11. Preferably, the neck extension 121 has a non-circular cross section, such as hexagonal cross section, while the tool socket 122 has a circular cross section.

According to the preferred embodiment, the hand tool 10 further comprises an electric motor 13 received in the handle 11 to drive the tool head 12 to rotate for forming an electric hand tool. Particularly, the tool socket 122 is operatively connected to the electric motor 13, such that when the electric motor 13 is operated, the electric motor 13 is arranged to generate a rotational force to drive the tool socket 122 to rotate. A control panel 14 is provided on the peripheral surface 111 of the handle 11 at one of the flat planar surfaces thereof and is operatively connected to the electric motor 13 to control an operation of the electric motor 13. The control panel 14 comprises a plurality of control switches to selectively control the element motor 13. For example, an on-and-off control switch is configured to power on and off the electric motor 13, a rotatable direction switch is configured to select the rotatable direction of the tool socket 122, and speed controlling switches are configured to control the rotational speed of the tool socket 122 by means of the rotatable power generated by the electric motor 13. The hand tool 10 further comprises a rechargeable battery 16 received in the handle 11 to electrically connect to the electric motor 13 and a charging terminal 17 provided at the second end of the handle 11 to charge the rechargeable battery 16 when connecting to an external power source via a charging cable.

According to the preferred embodiment, the hand tool 10 further comprises a cap 15 detachably coupled at the first end of the handle 11 to enclose the tool head 12. Accordingly, the cap 15 is a hard case having a uniform cross section matching with the cross section of the handle 11, such that when the cap 15 is coupled to the handle 11, the handle 11 and the cap 15 form a one piece member with an uniform cross section. In one embodiment, the cap 15 has a hexagonal cross section to define six planar surfaces aligning with and extending from the six planar surfaces of the handle 11 respectively. It is worth mentioning that the cap 15 has a closed end and an opened end defining a cap opening to receive the tool head 12 therethrough when the cap 15 is coupled at the handle 11. It is worth mentioning that the cap 15 is made of the same material of the handle 11 to create an uniform body structure when the cap 15 is coupled at the handle 11.

According to the preferred embodiment, the handle sleeve 21 is made of elastic anti-slip material, preferably the handle sleeve 21 is made of silicon, wherein the handle 11 of the hand tool 10 is snug-fitted in the handle sleeve 21 end-to-end. In other words, the handle 11 is coaxially sleeved in the handle sleeve 21. In one embodiment, the handle sleeve 21 has two opened ends and an uniform outer diameter. A length of the handle 11 matches with a length of the handle sleeve 21, such that when the handle 11 is received in the handle sleeve 21, the first and second ends of the handle 11 are received at two opened ends of the handle sleeve 21 respectively.

In one embodiment, an inner cross section of the handle sleeve 21 matches with an outer cross section of the handle 11, such that the handle 11 can be fitted into the handle sleeve 21. In one embodiment, the handle sleeve 21 has an inner polygonal cross section defining a plurality of flat planar surfaces, wherein the flat planar surfaces integrally aligned edge-to-edge to form the inner surface 211 of the handle sleeve 21. In one example, the handle sleeve 21 has a hexagonal inner cross section to form six flat planar surfaces matching with the hexagonal outer cross section of the handle 11. It is worth mentioning that when the handle 11 is received in the handle sleeve 21, the tool head 12 is extended out of one opened end of the handle sleeve 21, such that the tool socket 122 can be freely rotated when the electric motor 13 is powered on. It is worth mentioning that the handle sleeve 21 has an outer circular cross section and an inner non-circular cross section.

Accordingly, the second retention structure 214 is integrated with the inner surface 211 of the handle sleeve 21. In one embodiment, the second retention structure 214 forms with at least one of the flat planar surfaces. It is appreciated that the second retention structure 214 is integrated with the handle sleeve 21 to have a non-circular cross section to match with the cross section of the handle 11. In other words, the second retention structure 214 is integrally formed with at least one corresponding second flat planar surface at the inner surface 211 of the handle sleeve 21 to frictionally engage with the first flat planar surface of the first retention structure 112.

In one embodiment, the anti-slip arrangement 213 comprises two or more anti-slip patterns 2131, 2132 integrally formed at the outer surface 212 of the handle sleeve 21, such that when the handle sleeve 21 is gripped, the user's hand is able to physically contact with two different anti-slip patterns 2131, 2132 to enhance the gripping ability of the handle sleeve 21. As shown in FIGS. 16 to 19 and 22 to 23, the anti-slip patterns are dotted patterns 2131 and ribbed patterns 2132 spacedly formed on the outer surface 212 of the handle sleeve 21. For example, two dotted patterns 2131 and two ribbed patterns 2132 are formed on the handle sleeve 21 in an alternating manner.

The handle sleeve 21 further has a control window 215 which is a through window formed on the outer surface 212 of the handle sleeve 21. Particularly, the control window 215 is formed at one of the flat planar surfaces of the handle sleeve 21 to align with the control panel 14, such that the control panel 14 can be accessed through the control window 215 when the handle 11 is received in the handle case 21.

According to the preferred embodiment, the detachable handle case 20 further comprises a tool head cover 22 detachably coupled to the hand tool 10 to snug-fit the tool head 12 in the tool head cover 22 so as to protect the tool head 12 from being damaged. The tool head cover 22 is made of same material of the handle sleeve 21, such that the tool head cover is made of elastic anti-slip material, such as silicon.

The tool head cover 22 has an opened end and a closed end to define a cover cavity 220 for receiving the tool head 12 therein. Particularly, the tool head cover 22 has a base portion 221 defining the opened end thereat and a tip portion 222 defining the closed end thereat. A thickness of the tool head cover 22 matches with a thickness of the handle sleeve 21.

The base portion 221 of the tool head cover 22 is shaped and sized corresponding to the handle sleeve 21, wherein the neck extension 121 of the tool head 12 is snug-fitted in the base portion 221 of the tool head cover 22. Preferably, the base portion 221 of the tool head cover 22 has a non-circular inner cross section matching with the cross section of the neck extension 122. In one embodiment, the base portion 221 of the tool head cover 22 has a hexagonal inner cross section matching with the hexagonal cross section of the neck extension 122. The outer cross section of the base portion 221 of the tool head cover 22 matches with the outer cross section of the handle sleeve 21. In one embodiment, the base portion 221 of the tool head cover 22 has a circular outer cross section matching with the circular outer cross section of the handle sleeve 21, such that when the tool head 12 is snug-fitted in the tool head cover 22, the handle sleeve 21 and the tool head cover 22 are aligned and formed with each other as a one-piece integrated member. It is worth mentioning that when the handle sleeve 21 and the tool head cover 22 are coupled edge-to-edge, a connection edge between the handle sleeve 21 and the tool head cover 22 is sealed with air-tight and water resistance ability.

The tip portion 222 of the tool head cover 22 is integrally extended from the base portion 221 of the tool head cover 22, wherein the tip portion 222 of the tool head cover 22 is formed in a tubular shape having an outer diameter smaller than an outer diameter of the base portion 221 of the tool head cover 22, and an inner diameter matching with an outer diameter of the tool socket 122 for enclosing the tool socket 122 in the tip portion 222 of the tool head cover 22. Preferably, the tip portion 222 of the tool head cover 22 has a circular outer cross section and a circular inner section.

According to the preferred embodiment, the user, especially for the user having a smaller hand size, is able to directly grip the handle 11 of the hand tool 10 without the handle sleeve 21. Since the handle 11 of the hand tool 10 is made of hard and rigid material, the user may feel uncomfortable after a period of usage time. Once the handle 11 of the hand tool 10 is sleeved in the handle sleeve 21, an overall diameter size of the hand tool 10, i.e. the outer diameter of the handle sleeve 21, is enlarged for the user, especially for the user having a bigger hand size, to grip easily. Since the handle sleeve 21 is made of relatively soft material, the user is able to grip the hand tool 10 comfortably for a period of usage time.

In order to use the hand tool 10 of the present invention, the user is able to remove the tool head cover 22 from the tool head 12 to expose the tool socket 122, such that the tool bit can be detachably coupled at the tool socket 122. Once the electric motor 13 is switched on, the tool socket 122 is drive to rotate so as to rotate the tool bit at the same time. It is worth mentioning that when the tool head 12 is snug-fitted in the tool head cover 22, the outer surface of the tool socket 12 is contacted with the inner surface of the tip portion 222 of the tool head cover 22. Once the electric motor 13 is switched on, the rotatable power at the tool socket 12 will transform into a vibration at the tip portion 222 of the tool head cover 22. As a result, the hand tool 10 will serve as a vibrating massager for the user. Especially, the hand tool 10 can be a pressure point massager by applying the tip portion 22 of the tool head cover 22 at the pressure point of the user to ease muscle soreness and to increase blood flow of the user. It is worth mentioning that when the anti-slip arrangement 213, such as the dotted patterns 2131, is integrally formed at the outer surface of the tool head cover 22, the hand tool 10 can be formed as a female vibrator. Since the handle sleeve 21 and the tool head cover 22 of the detachable handle case 20 are made of waterproof material, the handle sleeve 21 and the tool head cover 22 can be removed from the hand tool 10 for washing and cleaning by water. It is worth mentioning that when the handle 11 and the tool head 12 are received in the handle sleeve 21 and the tool head cover 22 respectively, the handle sleeve 21 and the tool head cover 22 are coupled with each other edge to edge to form a sealing connection edge. In other words, the sealing connection edge is formed at a connection between the handle sleeve 21 and the tool head cover 22 to prevent any dust, water or moisture entering into the detachable handle case 20 through the sealing connection edge.

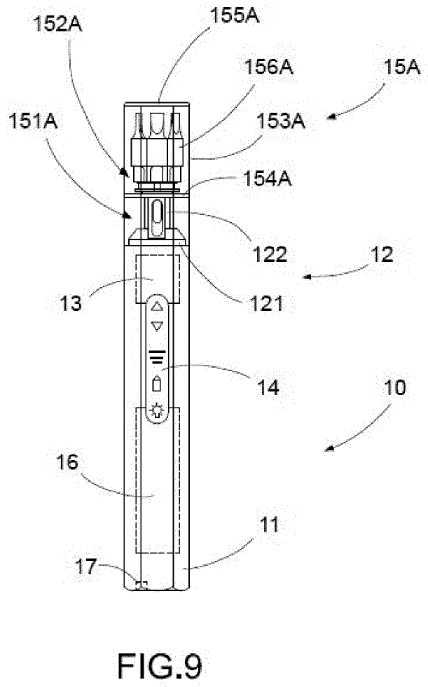

FIGS. 9 to 15 illustrates an alternative mode of the hand tool 10 including all the same structural configurations of the above preferred embodiment except the cap 15A. Accordingly, the cap 15A has a cap portion 151A detachably coupled at the first end of the handle 11 to enclose the tool head 12 and a bit storage portion 152A for receiving one or more tool bits to be detachably coupled at the tool socket 122. The cap 15A comprises a hollow surrounding wall 153A and a divider wall 154A formed within the surrounding wall 153A to define the cap portion 151A within the divider wall 154A and a bottom portion of the surrounding wall 153A, and the bit storage portion 152A within the divider wall 154A and an upper portion of the surrounding wall 153A. In other words, the cap 15A has two opened ends, wherein the cap portion 151A and the bit storage portion 152A are divided by the divider wall 154A. Preferably, a space of the cap portion 151A is smaller than a space of the bit storage portion 152A. A depth of the cap portion 151A is larger than a length of the tool head 12, while a depth of the bit storage portion 152A is larger than a length of each of the tool bits.

The cap 15A further comprises a detachable cover panel 155A detachably coupled at one opening end of the surrounding wall 153A to detachably enclose the bit storage portion 152A, and a bit holder 156A disposed in the bit storage portion 152A for releasably holding the tool bits in the bit storage portion 152A.

In order to select the bit tool, the user is able to detach the detachable cover panel 155A from the surrounding wall 153A to open up the bit storage portion 152A. Then, the bit holder 156A can be taken out from the bit storage portion 152A to detach one of the tool bits from the bit holder 156A in order to couple the selected tool bit at the tool socket 122. Preferably, the cap 15A is made of transparent material, such that the bit storage portion 152A can be seen through.

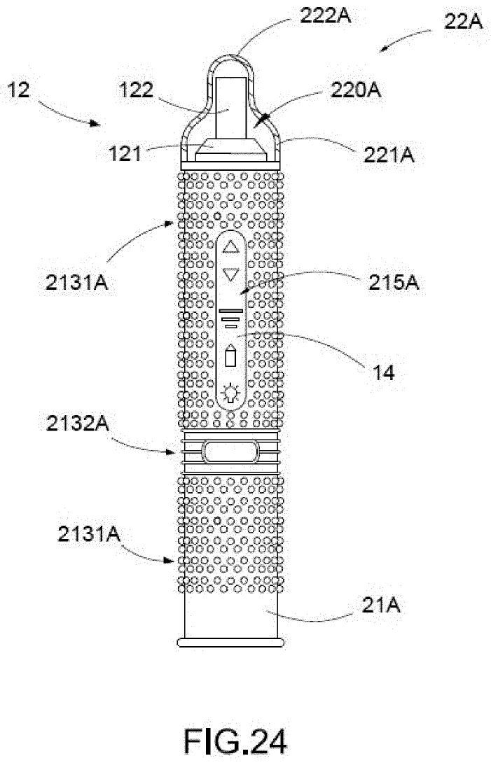

FIGS. 24 to 30 illustrates an alternative mode of the detachable handle case 20A which has the same structural configuration of the above preferred embodiment. The handle sleeve 21A of the detachable handle case 20A has the second retention structure 214A formed with the inner surface 211A and the control window 215A. Likewise, the tool head cover 22A has an opened end and a closed end to define the cover cavity 220A for receiving the tool head 12 therein. Particularly, the tool head cover 22A has the base portion 221A defining the opened end thereat and the tip portion 222A defining the closed end thereat.

Accordingly, the alternative mode illustrates another example of the anti-slip arrangement 213A, wherein two dotted patterns 2131A are formed at two end portions of the handle sleeve 21A while one ribbed pattern 2132A is formed on the handle sleeve 21A between the dotted patterns 2131A. Furthermore, the tool head cover 22A is made of transparent material to detachably couple to the hand tool 10 so as to snug-fit the tool head 12 in the tool head cover 22A.

It is worth mentioning that the two different alternative modes are the modification of the preferred embodiment. All the features in the preferred embodiment and its alternatives are interchangeable to achieve the objective of the present invention. For example, the alternative modes of the cap 15A and the detachable handle case 20A can be incorporated with the preferred embodiment.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An apparatus, comprising:
a hand tool which comprises an elongated handle and a tool head extended from a first end of said handle, wherein said handle has a peripheral surface and a first retention structure formed thereon; and
a detachable handle case, which comprises:
a handle sleeve having a hollow structure for receiving said handle of said hand tool therein and defining an inner surface and an outer surface, wherein said handle sleeve comprises an anti-slip arrangement formed at said outer surface and a second retention structure formed on said inner surface to engage with said first retention structure for preventing a relative movement between said handle sleeve and said handle.

2. The apparatus, as recited in claim 1, wherein said tool head comprises a neck extension extended from said first end of said handle and a tool socket extended from said neck extension for detachably coupling a tool bit, wherein when said handle is sleeved in said handle sleeve, said tool head is protruded out of said handle sleeve.

3. The apparatus, as recited in claim 2, wherein said hand tool further comprises an electric motor received in said handle to drive said tool socket to rotate for forming an electric hand tool.

4. The apparatus, as recited in claim 2, wherein said detachable handle case further comprises a tool head cover detachably coupled to said hand tool to snug-fit said tool head in said tool head cover, wherein said tool head cover has a base portion detachably coupled at said neck extension and a tip portion enclosing said tool socket therein.

5. The apparatus, as recited in claim 3, wherein said detachable handle case further comprises a tool head cover detachably coupled to said hand tool to snug-fit said tool head in said tool head cover, wherein said tool head cover has a base portion detachably coupled at said neck extension and a tip portion enclosing said tool socket therein.

6. The apparatus, as recited in claim 4, wherein said base portion of said tool head cover has an inner cross section matching with an outer cross section of said neck extension and an outer cross section matching with an outer cross section of said handle sleeve, wherein said tip portion of said tool head cover is integrally extended from said base portion of said tool head cover, wherein said tip portion of said tool head cover is formed in a tubular shape having an outer diameter smaller than an outer diameter of said base portion of said tool head cover, and an inner diameter matching with an outer diameter of said tool socket, such that when said the tool socket is enclosed in said tip portion of said tool head cover, an outer surface of said tool socket is contacted with an inner surface of said tip portion of said tool head cover.

7. The apparatus, as recited in claim 5, wherein said base portion of said tool head cover has an inner cross section matching with an outer cross section of said neck extension and an outer cross section matching with an outer cross section of said handle sleeve, wherein said tip portion of said tool head cover is integrally extended from said base portion of said tool head cover, wherein said tip portion of said tool head cover is formed in a tubular shape having an outer diameter smaller than an outer diameter of said base portion of said tool head cover, and an inner diameter matching with an outer diameter of said tool socket, such that when said the tool socket is enclosed in said tip portion of said tool head cover, an outer surface of said tool socket is contacted with an inner surface of said tip portion of said tool head cover.

8. The apparatus, as recited in claim 5, wherein said anti-slip arrangement is further provided at an outer surface of said tool head cover.

9. The apparatus, as recited in claim 1, wherein said handle sleeve is made of elastic anti-slip material that said handle of said hand tool is snug-fitted in said handle sleeve end-to-end.

10. The apparatus, as recited in claim 7, wherein said handle sleeve is made of elastic anti-slip material that said handle of said hand tool is snug-fitted in said handle sleeve end-to-end.

11. The apparatus, as recited in claim 1, wherein said anti-slip arrangement comprises two or more anti-slip patterns integrally formed at said outer surface, wherein said anti-slip patterns are dotted patterns and ribbed patterns spacedly formed on said outer surface of said handle sleeve.

12. The apparatus, as recited in claim 10, wherein said anti-slip arrangement comprises two or more anti-slip patterns integrally formed at said outer surface, wherein said anti-slip patterns are dotted patterns and ribbed patterns spacedly formed on said outer surface of said handle sleeve.

13. The apparatus, as recited in claim 1, wherein said first retention structure comprises at least a first flat planar surface integrated with said peripheral surface of said handle, wherein said second retention structure comprises at least a corresponding second flat planar surface integrated with said inner surface of said handle sleeve to frictionally engage with said first flat planar surface.

14. The apparatus, as recited in claim 10, wherein said first retention structure comprises at least a first flat planar surface integrated with said peripheral surface of said handle, wherein said second retention structure comprises at least a corresponding second flat planar surface integrated with said inner surface of said handle sleeve to frictionally engage with said first flat planar surface.

15. The apparatus, as recited in claim 3, wherein said hand tool further comprises a control panel provided on said peripheral surface of said handle and operatively connected to said electric motor, wherein said handle sleeve further has a control window formed on said outer surface of said handle sleeve to align with said control panel when said handle is sleeved in said handle sleeve.

16. The apparatus, as recited in claim 14, wherein said hand tool further comprises a control panel provided on said peripheral surface of said handle and operatively connected to said electric motor, wherein said handle sleeve further has a control window formed on said outer surface of said handle sleeve to align with said control panel when said handle is sleeved in said handle sleeve.

17. The apparatus, as recited in claim 1, wherein an inner cross section of said handle sleeve matches with an outer cross section of said handle, wherein said inner cross section of said handle sleeve and said outer cross section of said handle are non-circular cross section.

18. The apparatus, as recited in claim 16, wherein an inner cross section of said handle sleeve matches with an outer cross section of said handle, wherein said inner cross section of said handle sleeve and said outer cross section of said handle are non-circular cross section.

19. The apparatus, as recited in claim 1, wherein said handle sleeve has two opened ends and a uniform outer diameter, wherein a length of said handle sleeve matches with a length of said handle.

20. The apparatus, as recited in claim 18, wherein said handle sleeve has two opened ends and a uniform outer diameter, wherein a length of said handle sleeve matches with a length of said handle.
